(19) United States
(12) Patent Application Publication
(10) Pub. No.: US 2023/0043315 A1
(43) Pub. Date: Feb. 9, 2023

(54) METHODS AND DEVICES FOR DETERMINATION OF POSITION AND CONTROL OF LOCATION-BASED BEHAVIOUR ON A MODEL RAILROAD

(71) Applicant: EXCELLENCY KRISTIANSEN, MOSS (NO)

(72) Inventor: ulrik qvist kristiansen, moss (NO)

(21) Appl. No.: 17/785,416

(22) PCT Filed: Dec. 19, 2020
(86) PCT No.: PCT/NO2020/050323

§ 371 Date: Jun. 15, 2022

(30) Foreign Application Priority Data
Dec. 20, 2019 (NO) 20191494

(51) Int. Cl. B61L 25/02; A63H 19/24; G01C 22/02; B61C 3/00; B61L 27/20

(52) U.S. Cl. CPC B61L 25/025; A63H 19/24; G01C 22/02; B61C 3/00; B61L 27/20

(57) ABSTRACT

A method to determine the position of a locomotive (100) by having a first device (306) measuring the electromotive force from a propelling motor (105) and calculating the speed; combined with detection of fixed reference points by measuring of the magnetic field generated by permanent magnets (106) at known positions. At regular intervals this information is passed to a second device (108). By use of a pattern recognition algorithm the second device estimates the position and operates the locomotive according to location-based behavior. The first device characterized by having a magnetic field sensor (302) integrated on an ordinary model railroad decoder, which already supports motor measurement and packet transmission. The second device characterized by having a data packet receiver (403) and an Ethernet interface (405) for communication with a command station (109). A microcontroller (402) utilizes a parameterized representation of the model railroad layout to determine the position of the locomotive. From the position proper behavior is determined and corresponding speed commands are sent to the command station. Other methods and embodiments are described and shown.

### BACKGROUND OF THE INVENTION

The following is a tabulation of some prior art that presently appears relevant:

U.S. Patents

| Patent Number | Kind Code | Issue Date | Patentee |
|---|---|---|---|
| 8,154,227 | B1 | 2012 Apr. 10 | Young et al. |
| 7,137,600 | B2 | 2006 Nov. 21 | Lenz |
| 7,028,955 | B2 | 2006 Apr. 18 | Young et al. |
| 6,539,292 | B1 | 2003 Mar. 25 | Ames |

Foreign Applications Publications

| | Country | Kind | | |
|---|---|---|---|---|
| Foreign Doc. Nr. | Code | Code | Pub. Dt. | Applicant |
| 2,563,398 | GB | A | 2018 Dec. 19 | Jones |
| 20 2004 001 035 | DE | U1 | 2004 May 6 | Kuhlmann |

### Non-Patent Literature Documents

National Model Railroad Association (NMRA) standard documents S-9.1, S-9.1.1, S-9.1.2, S-9.2, S-9.2.1, and S-9.2.2 of the Digital Command Control (DCC) standard.

NMRA standard document S-9.3.2 of the DCC bi-directional standard.

An operator of a model railroad layout must often act as a signalman controlling turnouts and signals, but also as engine driver for all running locomotives. This is because no easy solution enables the locomotives to brake automatically at signals at danger. The human brain's limited capacity for multitasking essentially limits the number of simultaneously running locomotives—to a few. Removing the responsibility as engine driver from the operator will allow this person to operate many more simultaneously running locomotives and allow time for general enjoyment of the layout. Solutions for automatic braking at signals at danger has as a consequence been suggested through the past.

Since the introduction in the 1990s most model railroad layouts have become digitally controlled by having decoders in each locomotive receiving digital coded signals transmitted from a command station powering the tracks. This enables each locomotive to be individually controlled anywhere on the layout from the command station by the operator.

However, because the command station is unaware of the position of the locomotives, they cannot be controlled in an automatic manner based on location. A method for achieving location-based behavior is given in U.S. Pat. No. 7,137,600 to Lenz (2006). This patent describes an asymmetrical signal and an apparatus for injection the signal into an electrical isolated track section in front of the signal. Supported decoders detect this asymmetrical signal and brakes within a predetermine braking distance. This method has some drawbacks, where one is that the chosen braking distance must be equal for all signals on the entire layout. This introduces complexity because the chosen braking distance must be long enough to allow a realistic slow deceleration of high speed trains, yet not so long that:
a) the distance exceeds the length of any track at any station, because the isolated track section then expands into the area containing turnouts and the isolation becomes difficult;
b) the distance exceeds the distance between any two signals, because a locomotive stopped at the first signal cannot obtain the braking distance up to the second signal.

Further the method suffers by having the chosen distance programmed into the locomotives. Consequently they cannot be used on other layouts without first being reprogrammed. Similarly cannot different layouts be combined together without haven been intentionally designed with the same chosen distance.

The challenge of getting location-based behavior can also be addressed by a different approach, by connecting a computer to the command station by a digital interface, e.g. Ethernet. From the prospective of the command station, the computer will act as a human operator issuing instructions. Therefore the command station does not have to utilize automation, as the computer does the necessary calculations. The computer can estimate the position of the locomotives from a number of different methods described below. The computer can e.g. run the TrainController program from Freiwald Software, Germany.

As said, a number of methods for getting the position of the locomotives exist. A first method is to have sensors along the track at known positions, hereafter called reference points. The sensors can be based on infrared light as in U.S. Pat. No. 7,028,955 to Young et al. (2006), U.K. application number 2,563,398 to Jones (2018), and U.S. Pat. No. 8,154,227 to Young et al. (2012), reed switches, RFID tags as in U.S. Pat. No. 6,539,292 to Ames (2003), and U.S. Pat. No. 8,154,227, RF transponders, ultrasound, proximity, camera, barcodes etc. Many of these principles are binary in nature, meaning that they only take two states; either they detect a locomotive or they do not. This raises an uncertainty principle between detection range and detection precision. In order to make sure the reference points are detected at high speed, the range of detection should be increased and consequentially the position is known with less precision.

A second method registers changes from track occupancy detectors, as changes happen when the locomotives pass intersections of electrical isolated track sections. Track occupancy detectors work by measuring whether there is a current consumption in the isolated track section. A problem is that only electrical conducting wheels affect the current consumption. Therefore poor cleanliness of tracks and wheels as well as cars with installation of current consuming elements such as light, has been reported by users to produce unreliable behavior. Also some trains e.g. multiple-unit trains can have the current consumption wheels only in one end or somewhere in the middle of the train, and therefore not breaking at the same position as other trains having a locomotive in the front.

Both methods though limit the computer's awareness of the position to the event at which the sensors or intersections are passed. In-between these events the computer calculates the position based on time since the event occurred multiplied by an estimated speed. The estimated speed is measured in a calibration process. When the remaining distance to any signal at danger is equal to the chosen braking distance, a command is issued to bring the locomotive to a stop. The decoder then decelerate the locomotive within the chosen distance.

This approach requires the locomotive to enter all braking sections with a constant speed that has been measured in a calibration process. The deceleration is solely determent by the decoder in the locomotive, and the computer does not receive any feedback. Any delay introduced from the locomotive enters the braking section until it receives the braking command, will introduce a displacement in the stop position equal to the delay multiplied by the estimated speed of the locomotive. It is therefore possible to use a second sensor closer to the signal, to indicate when the train is near the stop position. Instead of sending a stop command when the first sensor is activated, a threshold speed command is sent to let the train approach the signal at a lower speed. The stop command is sent when the second sensor is activated.

A third method has a computer receiving the position of each locomotive in a continuous manner, whereby the speed estimation and the related drawbacks above are eliminated. The positions must be transferred from the locomotives to the computer either by the track or by a wireless connection. The position must be calculated in the decoder by integrating the traveled distance. The suggested method for measuring the traveled distance is by using a tachometer in U.K. application number 2,563,398 and German application number 20 2004 001 035 to Kuhlmann (2004). None of these described solutions are commercial available and this could be due to the complexity of installing a tachometer. Many locomotives have the entire gearbox as an integrated part of the bogies leaving no space for detection on any rotating axis. Further, the applications use infrared light as reference points, and an infrared sensor must therefore be installed in a downward opening in the locomotive. On the layout infrared transmitters must be installed as reference points. The reference points need wiring—and electronics in case a unique ID is to be transmitted. Drilling is needed on the layout for installation and the transmitters will be visually observable.

In U.S. Pat. Nos. 6,539,292 and 8,154,227 is therefore suggested the use of passive RFID tags instead of infrared light. The problem with RFID is the size of the antenna in the locomotive and how to retrofit it inside the locomotive, as the location and orientation of the antenna is restricted. For reliable RFID detection the range of detection is assumed to have to be quite large and from the uncertainty principle this creates an imprecise location.

Yet a fourth method also involving a computer is to measure the position on the layout using ultrasound. The company GamesOnTrack A/S, Denmark, do this by having multiply transducers in the ceiling of the room and one in each running locomotive. Because of the slow speed of sound waves, the system can triangulate the position of the transducers in the three dimensional space, similar to the satellite based GPS system for outdoor use. The concern about this method is, that the transducers must be installed in openings in the locomotives. Many locomotives do not have this, and the manufacturer therefore shows marketing pictures, where the transducer is mounted on the roof of the locomotive. This visual appearance is not acceptable by many detail-oriented model collectors. Further, hidden areas on the layout is problematic for ultrasonic solutions and reflections from e.g. walls could affect the performance.

All the methods mentioned above suffer from a number of disadvantages:
a) The predetermined braking distance must be equal for all signals.
b) Layouts cannot be combined together if not intensionally designed for this. And locomotives must be reprogrammed to be used on other layouts.
c) Binary nature of detectors cause a conflict between optimizing for reliability or precision due to the uncertainty principle.
d) Detection affected by configuration of electrical conducting wheels.
e) The necessity of constant speed when passing detection sensors or intersections.
f) Position estimated by integration of a calibrated speed measurement rather than a direct measure of actual speed.
g) Complex installation of tachometers as some locomotives have the entire gearbox as an integrated part of the bogies leaving no space for a detector on any rotating axis.
h) Antenna, infrared light source or similar devices must be post-installed in the locomotive at a restricted location and orientation.
i) Post-installation of occupancy sensors after the layout has been build, means that the tracks must be removed, electrical isolated, and wires must be connected. This is hard because the tracks usually are placed sequentially and interlocking each other.
j) Reference points are visually observable.
k) Necessity to have a free line of sight between transducers and locomotives.

### Advantages

Accordingly several advantages of one or more aspects are as follows: to provide a solution where the reference points are non-binary in nature, invisible and easily installed without the need of wiring nor drilling, that allow for easy installation in the locomotives by simply replacing the replaceable decoder at any given location and orientation, and that determents the location-based behavior depending on algorithms working without assumptions about initial speed nor a predetermined braking distance. Other advantages of one or more aspects will be apparent from a consideration of the drawings and the ensuing description.

### DRAWINGS—FIGURES

FIG. 1 shows a system overview of one embodiment.

FIG. 2A is a flowchart representation of the process of creating a new signal.

FIG. 2B shows an example of the application running on the mobile device and the components of the user interface.

FIG. 3A shows the hardware parts and connections of the new decoder.

FIG. 3B shows the additional hardware parts and connections of the compound decoder.

FIG. 4A shows the hardware parts and connections of the processing device in one embodiment.

FIG. 4B shows the hardware parts and connections of the processing device in another embodiment.

FIG. 4C shows an alternative embodiment without a dedicated processing device.

FIG. 5A is an example of a model railroad layout and the corresponding parameterized representation in the table.

FIG. 5B is an example of a model railroad layout and the corresponding parameterized representation in the table after a signal has been inserted.

FIG. 6A is a flowchart representation of the main function of the software in the new decoder.

FIG. 6B is a flowchart representation of the software in the new decoder responsible for measuring the speed.

FIG. 6C is a flowchart representation of the software in the new decoder responsible for detecting the passing of a magnet.

FIG. 6D is a flowchart representation of the software in the new decoder responsible for receiving command packets and transmitting data packets.

FIG. 7A is a flowchart representation of the main function of the processing device responsible for the initialization and regulation of the speed of the locomotive.

FIG. 7B is a flowchart representation of the software in the processing device responsible for receiving command packets.

FIG. 7C is a flowchart representation of the software in the processing device responsible for finding the initial position.

FIG. 7D is a flowchart representation of the software in the processing device responsible for calculating the distance to the next signal at danger.

### DETAILED DESCRIPTION

### First Embodiment

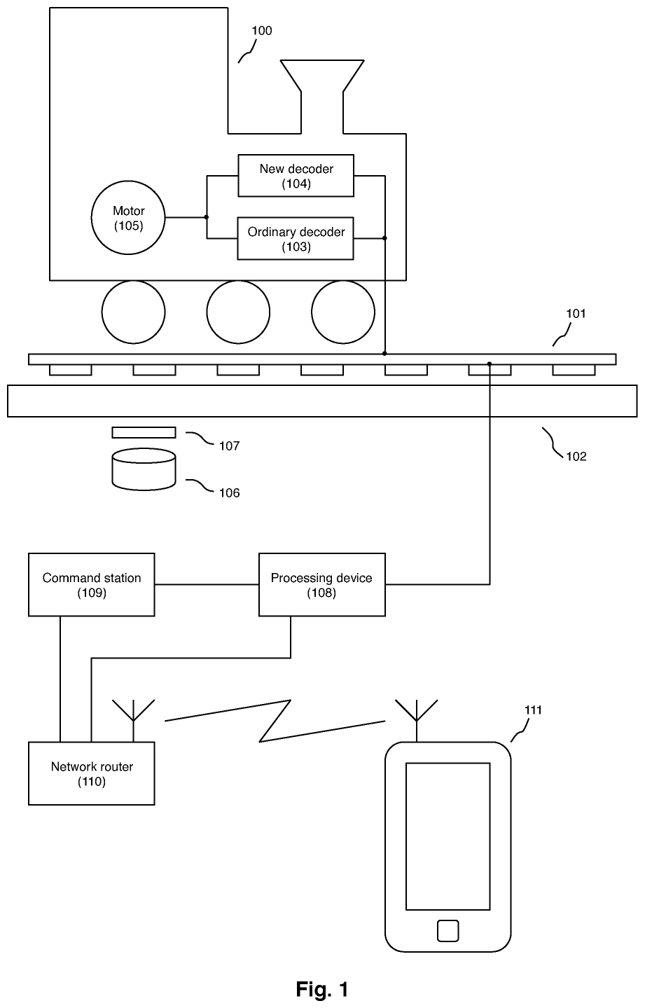

FIG. 1—System Overview

One embodiment is illustrated in FIG. 1. The embodiment has a model railroad locomotive (100) running on a track (101) on a baseboard (102). Inside the locomotive is an ordinary decoder (103) receiving power and control commands by the track and capable of controlling a motor (105). A new decoder (104) can furthermore transmit data packets in return by the track. The new decoder is also capable of measuring the electromotive force generated by the motor, as well as measuring a magnetic field in its proximity. The magnetic field is created by magnets (106) placed along the track underneath the baseboard having either the north pole or the south pole pointing upward. The magnets can be disc formed with a diameter of 15 mm and a height of 1 mm and mounted with adhesive double sided tape (107). The material of the magnets can be Neodymium, but the form, size, material and installation method is just an example and other specifications will also work. The magnets should be placed approximately at a distance equal to the track width to either of the side of the track, whereby each magnet can create four distinguishable magnetic fields; located on right side or left side of the track and with either north pole or south pole pointing upward.

The track is in one location electrically connected to a processing device (108) that is further connected to the user's command station (109). Both the command station and the processing device are connected with Ethernet cables to a network router (110). The network router provides a wireless network where a mobile device (111) is connected as well. The mobile device provides a user interface for interaction. The Ethernet protocol is just an example of a feasible network protocol but others can also be used. Further, the wired connections can be wireless.

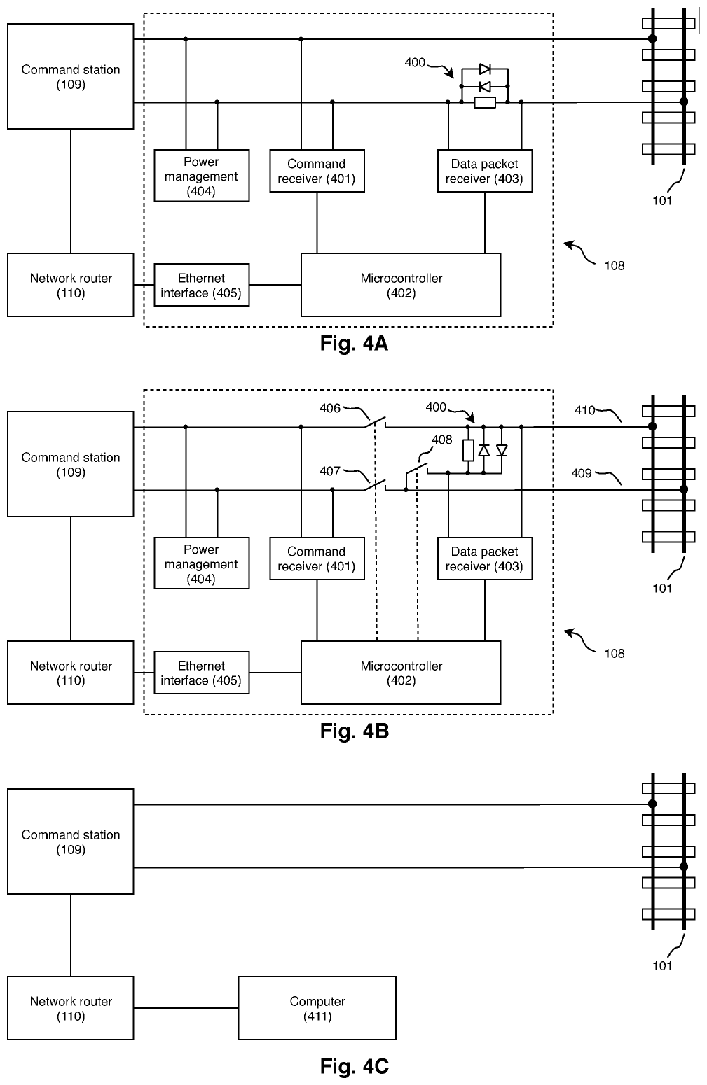

FIG. 3A—Hardware of New Decoder

In FIG. 3A is illustrated the parts of the new decoder (104) and its connections to the ordinary decoder (103). A motor sensor (300) capable of measuring a voltage generated by a motor (105) propelling the locomotive. The motor sensor measures the generated electromotive force from the motor and provides a scaled version of the voltage to a microcontroller (301). This microcontroller is connected to the magnetic field sensor (302). The magnetic field sensor can be a digital compass, e.g. LIS3MDL from ST Microelectronics. Other Hall effect sensors, MEMS sensors, digital compasses, inertial measurement units, or similar can also be used. Further, the microcontroller is connected to a command receiver (303) and a data packet transmitter (304). These circuitries are known in prior art and can support a number of model railroad communication standards. For this embodiment the command receiver will utilize the National Model Railroad Association (NMRA) Digital Command Control (DCC) standard. The data packet transmitter will utilize the NMRA DCC bi-directional standard, in which the necessary circuitry is explicitly specified. Other model railroad communication standards can also be chosen, and it is common practical to support a plurality of standards at the same time. Wireless communication is also an option. Both the command receiver and data packet transmitter are connected to the wires that pick up signals from the track (101). In addition is also connected a power management circuitry (305) that delivers power to the electronics of this new decoder. The power management circuitry comprising a diode bridge and a 100 uF capacitor for storing energy. The voltage across the capacitor will usually reach approximately 20 V and a low dropout voltage regulator is used to supply the lower voltage for the microcontroller, usually 3.3 volt.

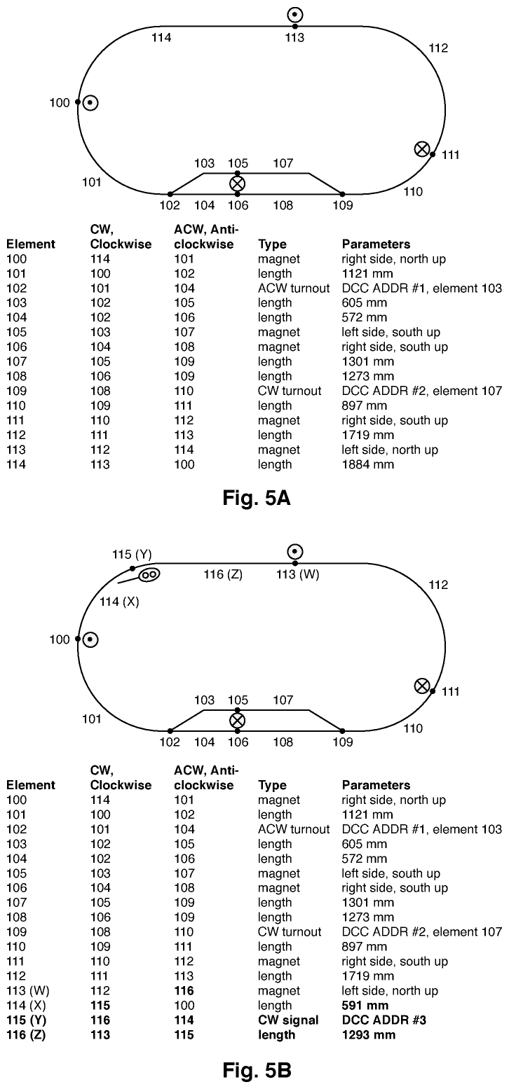

FIG. 4A—Hardware of Processing Device

In FIG. 4A is illustrated the parts of the processing device and its connections. The command station (109) has two output wires intended to be directly connected to the track (101). In this embodiment, however, they are instead connected through the processing device. In this first embodiment one of the connections passes through, while a current measurement circuitry (400) is inserted in the second connection. A circuitry for command receiving (401) is provided and connected to a microcontroller (402). Further a circuitry for data packet receiving (403) is provided and connected to the microcontroller. The same two mentioned standards by the NMRA are used but other alternatives exist. The microcontroller is powered from a power management circuitry (404) similar to the one described above. The microcontroller is further connected with an Ethernet interface (405). The Ethernet interface is connected to the network router (110) which is further connected to the command station.

### Operation—First Embodiment

The easiest way to understand how the system of this embodiment operates, is to visualize it as a pattern recognition system in combination with a speed regulation scheme. The new decoder in the locomotive will continuously report data packets to the processing device regarding passed magnetic reference points as well as the travelled distance. The processing device will have a parameterized representation of the track layout, and compare the reports with the parameterized representation to recognize a matching pattern of magnetic types and distances between them. The description will first discuss the parameterized representation and the placement of the magnets, followed by details about the new decoder and the creation of the data packet. Lastly the processing device will be discussed with details about algorithms.

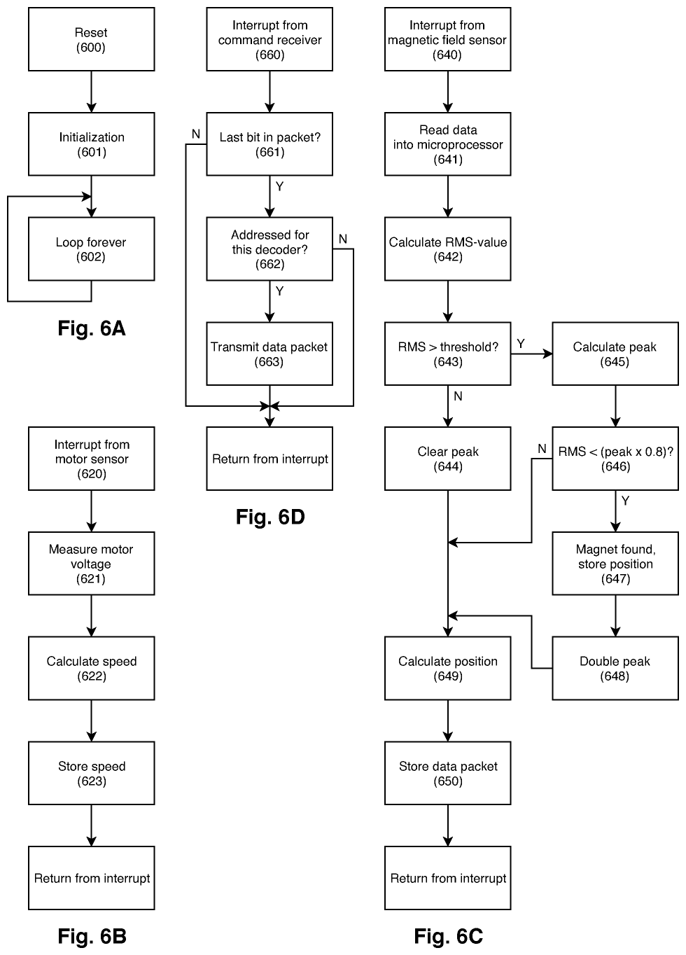

FIG. 5A—Creation and Utilization of the Database

The parameterized representation of the track layout can be implemented in a database, but is visually shown as a table in the description. It is not important how the database is implemented. Each row will be called an element in the following. An element comprising an element number, a clockwise reference, an anti-clockwise reference, type, and a parameter list. The clockwise and anti-clockwise references can be used as linked lists to find adjacent element numbers when traveling in the clockwise or anti-clockwise direction respectively. It will shortly be shown how the linked lists make it possible to easy find the route from one location to another. It will also be shown, how the distance between two magnets easily can be found by accumulating the length elements from first magnet to second magnet in the linked list.

The table can be created by running a locomotive over the tracks, whereby the processing device will receive the mentioned data packets, in which the type of passed magnets and the distance since last magnet can be read out. This information can be displayed to the user e.g. by the mobile device, such that the user can create the table.

An example of a layout and the corresponding database is viewed in table style in FIG. 5A. In the example, the user could choose to first run one round on the outer circle with the locomotive and thereafter run one round by using the side track. The user will have to decide the position of the turnouts (elements 102 and 109). Later in the description follows a method, where the front of the locomotive can be stopped just where the turnout begins, whereby the position can be automatically inserted in the table. However, it can also be entered by the user. From running the two rounds, the user will get the lengths between elements 100 and 105 (length_100_105) as well as elements 100 and 106 (length_100_106). The user then has to decide the length of 101, whereby the lengths of elements 103 and 104 can be calculated. First take a spare magnet and locate element 100 on the upper side of the baseboard. This is done by placing the spare magnet on the upper side of the baseboard in close proximity to the magnet underneath the baseboard. When the spare magnet is released, it will snap to the right position to form an axial alignment. Then measure the length following the track from the spare magnet to the beginning of the turnout by using a measuring tape (measured_length). Similar approach can be used for other turnouts. The following equations are valid for the turnout in element 102:

length of 101=measured_length
length of 103=length_100_105−measured_length
length of 104=length_100_106−measured_length

Magnet types are defined in the clockwise direction, so when traveling in the anti-clockwise direction, the right side and left side notations are interchanged.

Placement of Magnets

To insure proper performance of the pattern recognition algorithm, the magnets must be distributed along the track in a pseudorandom manner to produce a unique pattern. This is achieved by separating the magnets approximately by a distance of 20 to 200 cm. The resolution of the measured distance has been observed to be within +1-1%, but even with a resolution of +1-2.5%, this will create 47 distinguishable distances in the range. For a 1:87 scaled layout the magnets should be located approximately 3 cm on either side of the track measured from the center of the track to the center of the magnet. The upward magnetic polarity should also be randomly chosen and together this defines the magnetic type.

From the observation of three magnets, the likelihood of any combination is 1:141,376 (4×47×4×47×4), because the observation provides three magnetic types and two distances between them. On the layout is assumed to be only a few hundred magnets. The processing device can therefore determine the identification of the last passed magnet, given that the processing device has the knowledge of the last three passed magnets. The knowledge is delivered by data packets from the new decoder to the processing device. In the following is described the new decoder and the creation of the data packets.

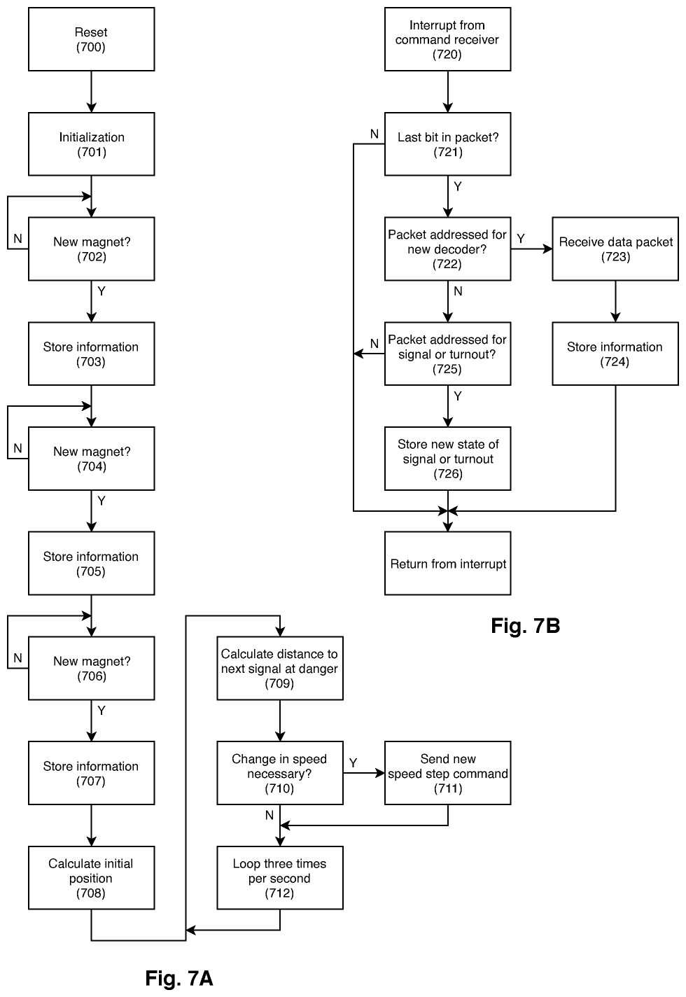

FIG. 6A—Main Flowchart of New Decoder

In FIG. 6A is illustrated the flowchart of the software running in the new decoder's microcontroller. The software can be written in the computer language C and implemented on a microprocessor or a microcontroller, e.g. ATSAML10D15 from Microchip. The software is solely based on interrupts, and the main program therefore goes as:

Step (600)

This it the entry point of the software.

Step (601)

The software starts by initializing the clock domain and peripheral blocks. The traveled distance is per definition zero at power-up, therefore the register holding the position of the locomotive is cleared.

position=0

Step (602)

Hereafter it enters an infinite loop with no functionality and all functionality is accomplished by interrupt routines.

FIG. 6B—Flowchart of Speed Measurement

The data packets are created based on the speed of the locomotive. The speed is measured from the voltage generated by the propelling motor when it is acting as a generator. Because the ordinary decoder also needs to measure this voltage in order to keep a constant speed compensated for load changes, it periodically stops driving the motor for a few milliseconds and the generated voltage can be measured. The generated electromotive force is proportional with the angular velocity of the motor shaft. The motor shaft has a fixed gear ratio with the wheels, and therefore the generated voltage is proportional with the speed. In FIG. 6B is illustrated the flowchart of the process.

Step (620)

When the motor sensor detects that the motor is not powered by the ordinary decoder, this interrupt is called. The non-powered state is detected when the PWM-signal to the motor disappears. This can be detected and generate an interrupt when the voltage has not exceeded a threshold for a given period of time. For example the threshold can be half the supply voltage and the period of time can be twice the period of the PWM signal. The interrupt can be generated in the suggested microcontroller by utilizing one analog comparator block and one timer block. The analog comparator checks against the threshold and clears the timer when it is exceeded. The timer counts the period and signals an interrupt, when the period exceeds the chosen period.

Step (621)

While the PWM-signal is absent, the electromotive force generated by the motor is measured by an ADC in the microcontroller. An average value is taken after the value has stabilized.

Step (622)

The speed is proportional to the measured voltage. However, each motor will require a unique multiplication factor necessary to transform the read voltage into millimeters per second. Therefore the ADC value is multiplied by a predetermined constant. The constant can initially be set to 1, and by running the locomotive manually over two magnets with a known distance between, the constant can be calculated from the reported distance in the data packet.

constant=measured_distance/reported_distance

Step (623)

The speed is stored in a global register accessible by the other interrupt routines.

FIG. 6C—Flowchart of Detection of Passing Magnet

The data packets are further created based on the passing of magnets. Now the measurement and detection of magnets will be described as illustrated in FIG. 6C.

Step (640)

The magnetic field sensor is initialized to generate an interrupt at a frequency of 300 Hz. The interrupt occurs when a new measurement of the magnetic field has finished and data is ready. The magnetic field sensor has a dedicated output pin for this interrupt generation.

Step (641)

The data from the magnetic field sensor is transferred into the microcontroller through a data interface, for example SPI or I2C.

Step (642)

The data consists of three values. They represent the magnetic field in the three dimensional orthogonal space of a reference frame. For simplicity the reference frame will match the frame of the locomotive such that is has the x-axis pointing in the forward direction, the y-axis pointing to the left side and the z-axis pointing upward. If the magnetic field sensor is not aligned like this, a three dimensional rotation of the recorded values is necessary for later processing. For now it holds to calculate the RMS-value, which is independent of the orientation.

RMS=SQRT(x\hat{ }2+y\hat{ }2+z\hat{ }2)

Other methods can be used to find an estimate of the magnetic strength. Especially when the orientation of the mentioned locomotive reference frame is known. In the event of passing a magnet, a specific pattern has been observed to occur in each of the three orthogonal magnetic fields. For the x-axis the field will have the strongest change and be zero exactly when passing the magnet. For the y-axis the field will peak exactly when passing the magnet. The z-axis is more complicated, but will be symmetrical around the magnet. Therefore, instead of using the RMS-value, many other values can be used, for instant:

value=y
or simply defining the passing to occur when the value of the x-axis changes polarity. However, in the following the RMS-value is used.

Step (643)

Check if the RMS-value is larger than a predetermined threshold. The purpose of the threshold is to remove peak detection based solely on fluctuations in the Earth's magnetic field. The value of the threshold should therefore be e.g. twice of the Earth's magnetic field.

Step (644)

The register peak is cleared.

peak=0

Step (645)

The register peak is set to the maximum value of RMS and peak itself. In another way, if the value of RMS is larger than peak, then:

peak=RMS

Step (646)

Check if the RMS-value is lower than 80% of the peak value. This indicates that the peak of the magnetic field has occurred and the magnet has been passed.

Step (647)

The information necessary for the data packet is the magnet type and the position of the locomotive when the magnet is passed. These values must be stored in global accessible registers accessible by the other interrupt routines. The current position of the locomotive is therefore remembered:

position_magnet=position

The magnetic type is determined based on two of the axes of the magnetic field of the reference frame. As said, if the measured magnetic field axes does not align with the frame of the locomotive, a three dimensional rotation must be performed. In the following alignment is assumed such that the rotation is not needed.

The measured signal in the x-axis when passing a magnet will increase toward a peak, then rapidly change toward a peak of opposite polarity, and finally go back toward the initial value. Therefore, at the closest position to the magnet, the value is crossing zero in a rapid change. Below is used a notation, where “x increasing” means that the transition goes from a negative peak toward a positive peak, and “x decreasing” means that the transition goes from a positive peak toward a negative peak.

If (y<0) & (x decreasing) then
type_magnet=right side, south up
If (y<0) & (x increasing) then
type_magnet=left side, north up
If (y>0) & (x decreasing) then
type_magnet=left side, south up
If (y>0) & (x increasing) then
type_magnet=right side, north up

Note that the sign of the signals can depend on the sign convention used by the manufacture of the magnetic field sensor.

Step (648)

The value of peak is doubled such that fluctuations will not trigger a new detection until the RMS-value has become less than the threshold and step (644) has cleared the peak.

peak=2×peak

Step (649)

The traveled distance is going to be calculated as an integration of the speed with respect to time. As the integration is carried out in a discrete manner by accumulation rather than a real mathematical integration, the time intervals between accumulations must be constant. Because this interrupt runs at a fixed frequency of 300 Hz, it is used to calculate the traveled distance. Since the locomotive is running on a guided track and always in one direction, the traveled distance corresponds with a position on the track. The traveled distance will therefore get the notation “position”.

position=position+(speed/300)

Step (650)

The data packet is created in case it is needed by the command receiver and data packet transmission interrupt routine described below. The data packet combines the position, position_magnet and type_magnet registers together into a bi-directional packet. As this has 32 bits available the first two registers should be 15 bits wide and the type register should be 2 bits wide. Both position and position_magnet are converted to integer numbers with a resolution of 1 mm.

FIG. 6D—Flowchart of Command Receive and Data Packet Transmission

Now when the data packet has been created, it needs to be transmitted on the track. As this embodiment uses NMRA DCC bi-directional standard for that purpose, strictly timing to the received command data is needed. In FIG. 6D is illustrated the flowchart of receiving command data and transmission of the data packet.

If the data packet is instead transmitted e.g. over a wireless connection, the data packet transmission will not have to be an integrated part of the command receiving interrupt. The data packet would then have to be transmitted periodically from 1 to 10 times per second.

Step (660)

Data communication occurs every time the track voltage toggles and this interrupt is triggered by the toggling. This step is assumed to gather the timing of toggles and translate this into a command data packet. This process is known to all developers of model railroad decoders and will therefore not be discussed further.

Step (661)

It is checked whether the data packet is complete. Unless it is the last bit, the interrupt is returned.

Step (662)

It is checked whether the data packet is addressed to this new decoder. If not, no transmission should occur and the interrupt is therefore returned. The address for the new decoder can be chosen arbitrary as long it is an unused address.

Step (663)

The data packet must now be transmitted. The timing of the transmission is given by the bi-directional standard. The actual encoding of the 32 bits is described in the standard. The standard also defines applicable opcodes for experimental usage which can therefore be used for this demonstration. The data packet has already been created in another interrupt routine and is globally accessible.

We now move our focus to the processing device. At this point the data packet has been created and transmitted. In the following is described how the data packet is received and processed.

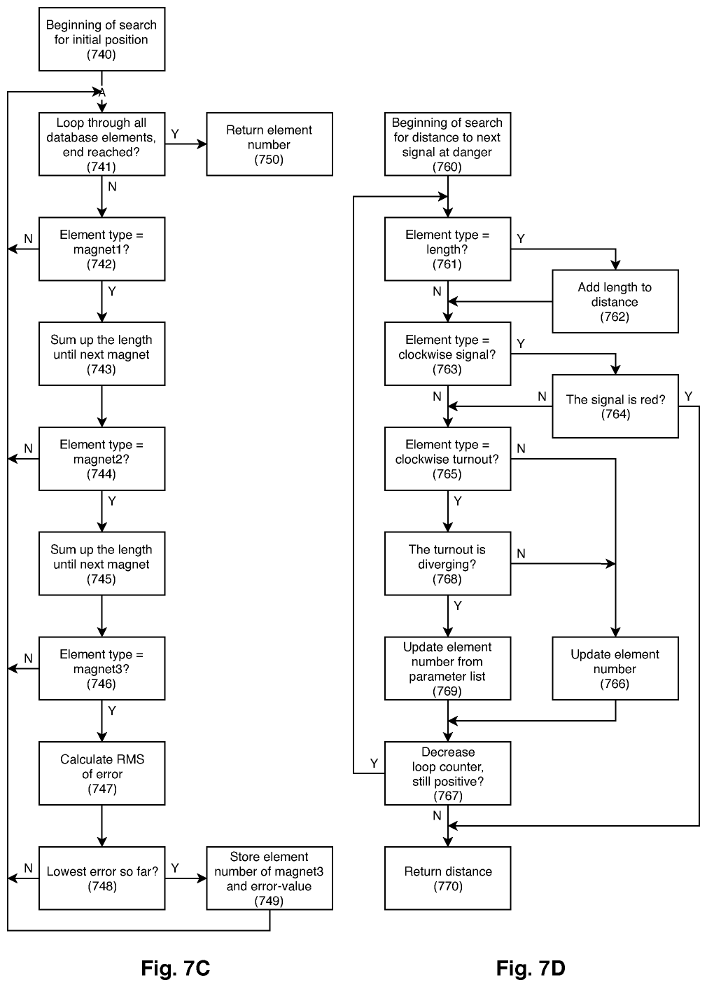

FIG. 7A—Main Flowchart of Processing Device

The data packets are received by the processing device described in the following. In FIG. 7A is illustrated the main flowchart of the software running in the processing device's microcontroller. The software can be written in the computer language C and implemented on a microprocessor or a microcontroller, e.g. ATSAME70Q21 from Microchip.

Step (700)

This it the entry point of the software.

Step (701)

The software starts by initializing the clock domain and peripheral blocks. Furthermore it sends a speed step command request for the new decoder using the arbitrary chosen address. The request goes to the command station by the Ethernet interface. This request makes the command station periodically send packets addressed to the new decoder. As only the response from the new decoder is of interest, the speed can be anything except zero. This is because some command stations will terminate the transmission of packets after a while for stopped locomotives. The format of the speed step command to be sent is defined by the command station manufacture.

Step (702)

After the processing device has been initialized, there will periodically be sent data packets to the address of the new decoder. The new decoder will answer these command packets with data packets. As the locomotive travels along the track, the data packet will have the position value increased by one for each millimeter it runs. The information regarding the last passed magnet will for must packets be equal to the information in the preceding packet. Only when a magnet is passed, will the content of this information be updated. The content is a copy of the position value when the magnet is passed in addition to the magnetic type.

The processing device receives data packets and waits for the magnetic information to change.

Waiting for the first data packet with new magnetic information.

Step (703)

Store the position of the magnet and magnetic type information.

magnet1=received magnetic type
position1=received position of magnet

Step (704)

Waiting for the second data packet with new magnetic information.

Step (705)

Store the position of the magnet and magnetic type information.

magnet2=received magnetic type
position2=received position of magnet

Step (706)

Waiting for the third data packet with new magnetic information.

Step (707)

Store the position of the magnet and magnetic type information.

magnet3=received magnetic type
position3=received position of magnet

Step (708)

Calculate the distances between the magnets as:

distance1=position2−position1

distance2=position3−position2

Search the database for an initial position based on the five registers above, magnet1, magnet2, magnet3, distance1 and distance2. Detailed description of this process follows shortly. The search algorithm should be called twice with the clockwise and anti-clockwise linked list calls used respectively. The best overall match should be used. The direction is determined from the overall best match from the clockwise and anti-clockwise searches. The direction should be remembered, because this is a used parameter elsewhere in the algorithms.

Assuming the initial position of the locomotive has now been found, the regulation of the speed of the locomotive can begin. The locomotive will run at the highest chosen speed until a signal at danger is found in the route the locomotive is going to take.

Step (709)

Search the database and calculate the distance to the next signal at danger. Detailed description of this process follow shortly. The process returns a value which is equal to the distance from the last passed magnet to the signal. The remaining distance to go should be subtracted by the distance already traveled since the last magnet was passed, which is equal to the received position subtracted by the received position of the magnet:

position_since_magnet=position−position_magnet

distance to_go=returned value−position_since_magnet

Because the position of the locomotive is actually the position of the new decoder inside the locomotive, the remaining distance should further be subtracted by a value equal to the length from the new decoder to the front of the locomotive. This way the front of the locomotive will stop in front of the signal regardless of the position of the new decoder in the locomotive:

distance to_go=distance to_go−length_to_front

The length to_front value is measured by the user when installing the new decoder.

Step (710)

Based on a calibration of the locomotive, the braking distance for each speed step has been automatically measured and is stored in a list. Alternatively the list is created from a user defined deceleration curve. A part of the list could be:

### Step 3: 30 mm

### Step 4: 50 mm

### Step 5: 90 mm

etc.

If the distance_to_go calculated in the step (709) is between 30 and 49 mm, then the locomotive should be running at speed step 3. If this is the case, then no change in speed is necessary and the flow proceeds to step (712).

Step (711)

However, if the locomotive is not running at speed step 3, then a new speed step command must be issued to the command station by the Ethernet interface. The new speed step should be as high as possible, but such that the distance in the table do not exceed the calculated distance_to_go. For example would a calculated distance_to_go of 85 mm results in a wanted speed step of 4. The list leads to a staircase step-down regulation of the speed of the locomotive all the way down to the stop position in front of the signal. The regulation is based on the received position from the data packet that is based on the measured motor voltage. It is observed that any delay in communication causes less inaccuracy as the speed gets lower. The final stop position is therefore very accurate and deviates only by a few millimeters. Furthermore, there is no demand for a constant speed when the braking starts. Neither must be braking have a fixed length, and the list above could be dynamically changed, e.g. when traveling downhill or when a large load is added to the locomotive. Further, the braking can start at any position regardless of the position of turnouts and the length to the previous signal. Many of the advantages of this invention come from this continuously regulation of speed based on the actual travelled distance, instead of the approach based on pre-measured calibration data and a predetermined braking length.

Step (712)

The steps (709, 710 and 711) forms a regulator that regulates the speed of the locomotive. The regulator must run at a periodic interval. Depending on the microcontroller the implementation can either be based on a timer or an inserted delay. The accuracy of the periodic interval is not important, anything between 1 to 10 times per second is acceptable, and therefore 3 times per second has been chosen as a target and is created by a delay of 333 milliseconds.

FIG. 7B—Flowchart of Command Receive

In FIG. 7B is illustrated the flowchart of the command receiver interrupt. This interrupt is called every time the voltage from the command station is toggled. It works similar to the command receiver in the new decoder, which has already been described.

Step (720)

Data communication occurs every time the track voltage toggles. This step creates the data command packet similarly to step (660).

Step (721)

It is checked whether the data packet is complete. Unless it is the last bit, the interrupt is returned.

Step (722)

It is checked whether the command packet is addressed to the new decoder. If this is not the case, then no data packet of interest will follow either, and the process can jump to step (725).

Step (723)

However, if the new decoder is addressed, it will send a data packet in return. The data packet is in this step received and decoded.

Step (724)

If the initial position has not been found, the execution of this step is omitted. Else, if the data packet contains new magnetic data, the element number found by the initial search will be updated. The element number will be equal to the element number of the next magnet in the database. This is found by following the element number in the linked list until the element type equals a magnet. The linked list to be used is equal to the direction of traveling. At this stage the interrupt is returned.

However, the travelled distance since last magnet can further be checked against the length of the database elements between the magnets. If the measured distance deviates considerable from the database length, an error handling can be implemented. Also the magnetic type reported by the data packet should match the magnetic type stored in the database.

Step (725)

It is checked whether the command packet is related to signals or turnouts. If not, the interrupt is returned.

Step (726)

If the packet is related to either a signal or a turnout, then the state of that is remembered. This can be as simple as a single bit in a global accessible array of signals and turnouts. The interrupt is then returned.

The states of signals and turnouts are necessary for carrying out the search in the database for next signal at danger. This is because the turnouts are responsible for determining which route the locomotive is going to take. On this route only approaching signals at danger are of interest.

In the following will be described the two processes referred to above. The descriptions use a notation where pointer.name refers to the value in the database of the row where “pointer” equals the element number and where “name” equals the wanted value, for example:

100.type=magnet,
105.clockwise=103 and
110.length=897 mm,
as seen in the database example in FIG. 5A.

FIG. 7C—Searching for an Initial Position

In FIG. 7C is illustrated the flowchart of the pattern recognition process. It is used to search of the initial position. The process is called from the processing device's main program after the first three magnets have been passed. The five inputs consist of three magnet types, magnet1, magnet2 and magnet3 and two distances between the magnets, distance1 and distance2.

The search is demonstrated carried out in the clockwise direction only, but by replacing the clockwise linked list calls with the anti-clockwise linked list calls, the search will be carried out in the anti-clockwise direction. Further, for the anti-clockwise direction the right/left notation of magnetic types should be interchanged.

Step (740)

Initialize the match register that should hold the element number of the found location and set the error register to an unrealistic high value.

match=0
error=1,000,000

Step (741)

Loops through all database elements. If end element is reached, the process jumps to step (750).

element=1, 2, 3, . . . , max

Step (742)

Check if the magnet type magnet1 matches the type of the element. If not, jump to step (741).

if element.type˜=magnet1 then jump

Step (743)

However, if it matches, the element number is updated by the clockwise linked list value.

element=element.clockwise

Now accumulate the length of all elements until an element of type magnet is reached.

sum1=0
while element.type˜=magnet then
sum1=sum1+element.length
element=element.clockwise

Step (744)

Similar to step (742), but checks against magnet2 instead.

Step (745)

Similar to step (743), but accumulates into sum2 instead.

Step (746)

Similar to step (742), but checks against magnet3 instead.

Step (747)

The two accumulated database lengths are compared to the two measured distances. An error is calculated as:

RMS=SQUARE_ROOT((distance1−sum1)\hat{ }2+(distance2−sum2)\hat{ }2)

Step (748)

Compares the RMS-value to the error register. If the RMS-value is lower than the error register, a new candidate for initial position has been found, and it is the best candidate so far. Therefore continue to next step.

Step (749)

Store the new best candidate.

match=element
error=RMS

Step (750)

Return the found element number in the register “match” to the calling function. Also store the register “error” such that the best overall result can be found.

FIG. 7D—Finding the Distance to Next Signal at Danger

In FIG. 7D is illustrated the flowchart of the process of finding the distance to the next signal at danger in the database.

The search is carried out in the clockwise direction only, but by replacing the clockwise linked list calls with the anti-clockwise linked list calls, the search will be carried out in the anti-clockwise direction. Also the check of element types should be changed from clockwise to anti-clockwise. The linked list to be used is equal to the direction of traveling.

Step (760)

The search for next signal at danger is initialized with one input; the element number to the last passed magnet. The lengths in the database will be accumulated into the register sum. A loop counter is sat to 100 to prevent an infinite loop scenario in case no signal is found at danger.

element=input to process, an element number
sum=0
loop=100

Step (761)

First the element type is checked against length.

if element.type=length, then continue with step (762).

Step (762)

The length of the element is accumulated in sum.

sum=sum+element.length

Step (763)

The element type is also check against clockwise signal.

If element.type=clockwise signal, then continue with step (764).

Step (764)

Check if the signal is red. This is achieved by finding the signal number in the parameter list and check if the corresponding bit in the array of signals and turnouts has been asserted. If this is the case, terminate the search by jumping to step (770).

Step (765)

Else check if the element type is clockwise turnout.

If element.type=clockwise turnout, then continue with step (768).

Step (766)

Else update the element to the next element in the linked list.

element=element.clockwise

Step (767) Check if the search has run through the element check enough times. If this is the case, continue to step (770).

loop=loop−1
If loop=0 then continue with step (770)

Else start over again with the new element number by jumping back to step (761).

Step (768)

If the element type was a clockwise turnout, now it is time to check which direction it takes. This is achieved by finding the turnout number in the parameter list and check if the corresponding bit in the array of signals and turnouts has been asserted. If this is not the case, the turnout is straight and the process jumps to step (766), because the element number in the linked list holds the straight element number.

Step (769)

However, if the turnout is diverging, the next element number is found in the parameter list. Then jump to step (767).

element=(element number from parameter list)

Step (770)

The distance from the last passed magnet to the signal at danger is equal to the value in “sum”. The result is returned from the process.

Now all the processes to exchange information, control locomotives and utilize the database has been described. In the following is described a user friendly approach to insert new signals in the database.

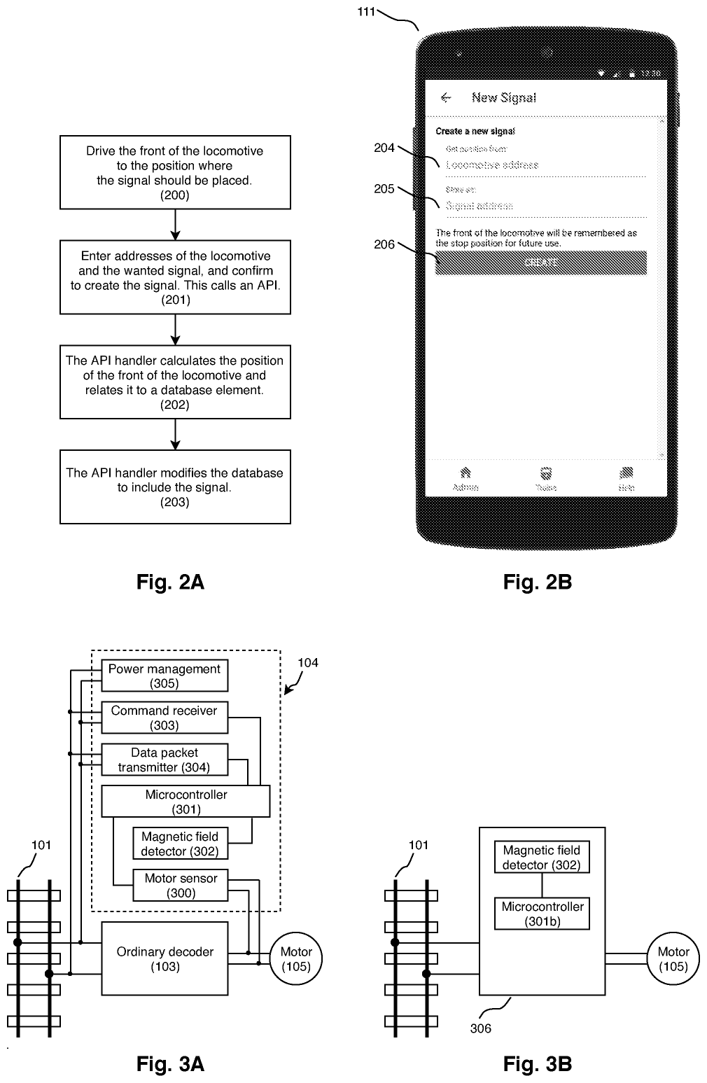

FIGS. 2A, 2B—Method for Defining the Location of New Signals

In order for the control algorithm to know when to brake a locomotive, the physical location of signals must be known and related to elements in the database.

In currently available commercial solutions the braking in front of signals is activated either by a dedicated piece of electronics connected to an isolated track section in front of each signal, or by a computer having a number of occupancy sensors connected to electrical isolated track sections. In either case, the position of a signal can be determined relative to the isolated track section.

However, this invention do not have isolated track sections nor does it utilizes visually identifiable reference points. It is therefore difficult for the user to determine the location of signals based on the reference points. Further, the magnets cannot be observed from a normal perspective at the layout because they are placed underneath the baseboard.

The invention therefore include a method for locating a point of interest and storing it in the database. The method is described for a signal, but the same approach can be used to locate turnouts, block sections etc. In FIG. 2A is shown a flowchart of the method and in FIG. 2B is shown an example of a mobile device application acting as the user interface.

Step (200)

The user drives a locomotive to the location, where the signal should be placed. It is assumed that the calculation of the initial position has occurred such that the processing device at this state knows the position of the locomotive.

Step (201)

From a computer, a dedicated hardware device, or a mobile device (111), the user is provided with a user interface. An example of a mobile device application is shown in FIG. 2B. The user is given a first input field (204) to enter the address of the locomotive and a second input field (205) to enter the address of the signal. When the user has entered the addresses, a button (206) allows the user to create the signal by pressing it. The mobile device application then calls an application programming interface (API) running on the processing device for creation of signals.

Step (202)

The API calculates the position of the front of the locomotive. Because the position data received from the locomotive is actually representing the position of the new decoder inside the locomotive, the position of the front should be calculated by adding a value equal to the length from the new decoder to the front of the locomotive. This way the front of the locomotive will be known as position_front:

position_front=position+length to_front

If the value of position_front exceeds the length of the current element, the linked list is used to determine a new element number. When the locomotive is facing in the clockwise direction:

position_front=position_front−element.length

until element.type=length do:

element=element.clockwise

If the value of position_front still exceeds the length of the element, repeat the above instructions.

Step (203)

Modify the database to include the signal at the given position of the front of the locomotive. The steps of this process is given in the following example.

FIG. 5B—Creation of New Signal in Database

In FIG. 5B is shown an updated version with a signal inserted in the database similar to the one in FIG. 5A. To generate the table in this example, the locomotive was driven clockwise to a location, such that the last passed reference point was element number 100, and the reported traveled distance since the reference point was 291 mm. If the new decoder in the locomotive was installed 300 mm from the front, the front of the locomotive will be totally 591 mm into element 114.

First two new elements are inserted in the database, called Y (element 115) and Z (element 116). Y becomes the signal, which will have the type clockwise signal. The address will be stored in the parameter column. Z is of the type length, and holds the remaining length of the element X (element 114) after subtraction of the distance the front has traveled into the element. W (element 113) is the original clockwise element to X. Insert in the database:

Z.length=X.length−front_into_element
X.length=front_into_element
Y.type=clockwise signal
Y.parameter=the address of the signal
Y.anti-clockwise=X
Z.anti-clockwise=Y
W.anti-clockwise=Z
X.clockwise=Y
Y.clockwise=Z
Z.clockwise=W

It is seen, that two new elements have been added and that three numbers in the old rows have been updated. These changes are marked with bold text in FIG. 5B.

From a user experience point of view, the method of defining a position based on the actual position of a locomotive, is a huge advantage from the ordinary trial and error approach used by commercial solutions today. The method can further be used to define other point of interests on the layout, e.g. turnouts.

### Second Embodiment

This embodiment describes a variant of the new decoder, which is based on an ordinary decoder. Some ordinary decoders have the motor sensor (300) for load compensation purpose and the data packet transmitter (304) for programming on the main track. They therefore have all the necessary hardware parts except for the magnetic field sensor (302).

This second embodiment is a combination of the new decoder functionality and the ordinary decoder functionality in a new single device called a compound decode (306), as shown in the FIG. 3B. The compound decoder has all the functionality both in sense of hardware and software as the ordinary decoder, and is therefore not shown in the figure. Only the change necessary to convert the ordinary decoder into a compound decoder is shown. The decoder can be converted simply by adding a magnetic field sensor (302) to the circuit board and connecting it to the microcontroller (301b) either by an SPI, I2C or similar interface provided by the sensor and supported by the microcontroller.

The compound decoder is beneficial because the locomotives only have one socket for a decoder. The user can then easily replace the ordinary decoder with the compound decoder in order to use this invention. At this point the benefit of having a three dimensional magnetic field sensor should be noticed. From the description of the first embodiment, it was seen: that the y-axis would had been enough to detect the magnets; and that the y-axis and the x-axis would have been enough to determine the magnetic type. However, with all three axes the decoder can obtain any orientation inside the locomotive. This ensures that the compound decoder will work regardless of the placement of the decoder socket.

### Operation—Second Embodiment

There is no difference in the operation of the second embodiment compared to the first embodiment, except that the processes shown in FIGS. 6A, 6B, 6C and 6D must be integrated with the software that usually runs in the microcontroller of an ordinary decoder. Because the processes mainly consist of interrupt handling, the integration should be uncomplicated. The integration depends heavily on the implementation of the ordinary decoder, on which the compound decoder is build, and therefore details cannot be described.

### Third Embodiment

In the first embodiment, the command station is assumed to support the DCC bi-directional standard. The standard defines a cutout period where the power to the track is removed and the track output is shorted to form a low impedance current loop. The decoders can then generate a current signal through the loop by introducing a small voltage on the track. In order to support as many modern command stations from different vendors as possible, the bi-directional functionality can be integrated into this invention. This way the invention can be used by more DCC command stations and even multi-protocol systems.

In FIG. 4B is illustrated a processing device with integrated bi-directional functionality. The two primary switches (406) and (407) are normally closed while the secondary switch (408) is normally open. All three switches are connected to the microcontroller (402). They must switch in a few microseconds, and therefore the use of solid state relays must be considered. They can be designed from the Texas Instruments reference design TIDA-01064. The command station (109) is connected to the two primary switches, which are connected to the track (101) on the other side. The current measurement circuitry (400) and the data packet receiver (403) connections are changed from the first embodiment. Instead of being connected in series with the connection to the track, they are connected in series with the current loop only. The current loop is going from one track rail (409) through the secondary switch (408), the current measurement circuitry (400), and to the other track rail (410).

### Operation—Third Embodiment

There is no difference in the operation of the third embodiment compared to the first embodiment, except that the primary switches (406) and (407) and secondary switch (408) must be controlled. The DCC bi-directional standard gives the timing requirements. It says that the primary switches must open 26 to 32 microsecond after the command receiver (401) has detected the last bit in a command packet. The switches must close again 454 to 488 microsecond after the last bit in a command packet. The secondary switch must be closed only while the primary switches are open and otherwise it must be open. The secondary switch should be closed as long as possible without introducing shoot-through of the output of the command station (109). The timing of the secondary switch therefore depends on the specifications of the solid state relays.

The mentioned control of the switches should occur only after packets addressed to the new decoder.

Most microcontrollers, including the one specified in the first embodiment, have dedicated peripherals to control switches in a timely manner. The software therefore needs only to activate a timer in the microcontroller, when the last bit in a packet is addressed for the new decoder. This modification can be added to step (723) in FIG. 7B.

Step (723)

This step additionally starts a timer. When the timer reaches 26 microseconds an interrupt is started, which opens the primary switches and closes the secondary switch. When the timer reaches 454 microseconds, yet another interrupt is started, which opens the secondary switch and closes the primary switches again.

### Fourth Embodiment

In FIG. 4C is illustrated yet another embodiment of the processing device, or literally speaking, the functionality of the processing device. Because some command stations (109) already support the DCC bi-directional standard, they have all the necessary hardware to receive data packets from decoders, including magnetic data from the new decoder. The functionality of the processing device can therefore be processed internally in the command station. Alternatively the command station can transfer the received data packets through a network router (110) to a computer (411) or similar processing device for processing. In other words, the functionality of the processing device can be implemented by software in already existing command stations and/or computers.

### Operation—Fourth Embodiment

There is no difference in the operation of the fourth embodiment compared to the first embodiment, except that the software described for the microcontroller (402) of the processing device must be integrated and combined with the software of the microcontroller in the command station (109). Alternatively, parts of the software can run on a computer (411) or similar processing device. In this alternative, the command station must provide the command packets via the computer network, such that the processing algorithms in the computer know the state of signals and turnouts, speed of locomotives etc.

### CONCLUSION, RAMIFICATION, AND SCOPE

Accordingly, the reader will see that methods and devices of the various embodiments can quite effortless be implemented to determine the position of a locomotive on a model railroad. With a known position of the locomotive, location-based behaviors can easily take place and greatly improve the user experience. Both in terms of installation and performance the solution is superior.

The first and second embodiments describe two versions of the decoder and the first, third and fourth embodiments describe three versions of the processing device. Even though only four embodiments have been described, it should be understood, that all six combinations of the two decoder versions and three processing device versions are feasible variations.

Although the description above contains many specificities, these should not be construed as limiting the scope of the embodiments but merely providing illustrations of some of several embodiments. For example the peak detection algorithm of FIG. 6C, the pattern recognition algorithm of FIG. 7C, and the database structure can all take different approaches leading to the same result. For some command stations other network protocols could be preferred over Ethernet. One such protocol could be LocoNet trademarked by Digitrax, which is designed to handle all the communication carried out by the Ethernet connection in the embodiments shown. The processing device could therefore include a LocoNet interface. Basically any kind of wired or wireless computer network would be a candidate, as the needed bandwidth is only a few kilobits per second.

Thus the scope should be determined not by the embodiments illustrated but the appended claims and their legal equivalents, rather than by the examples given.

I claim:

1. A method for identifying a position of a locomotive on a model railroad layout which has a plurality of permanent magnets distributed at known positions, comprising:
a) measuring an electromotive force generated by a motor propelling the locomotive;
b) integrating the measured electromotive force to yield an estimate of change in position of the locomotive;
c) measuring a magnetic field as the locomotive is moving on the model railroad layout;
d) providing a memory which is able to store a parameterized representation of the model railroad layout including the known positions of the permanent magnets;
wherein the improvement comprises,
e) determining when the permanent magnets are passed based on the measured magnetic field;
f) determining a first distance between a first passed magnet and a second passed magnet;
g) determining a second distance between the second passed magnet and a third passed magnet;
h) utilizing a means for searching the parameterized representation to determine an element with a best matching of the first distance and the second distance;
whereby the element represents the position of the locomotive on the model railroad layout.

2. A method for automatic braking of the locomotive in a desirable position specified in the parameterized representation of the model railroad layout according to claim 1 further comprising:
a) calculating a remaining distance to travel from the position of the locomotive to the desirable position by utilizing the parameterized representation of the model railroad layout;
b) providing a memory which is able to store a predetermined listing of maximum allowed speed for the locomotive as function of the remaining distance;
c) regulating the speed of the locomotive in according with the predetermined listing of maximum allowed speed for the locomotive based on the remaining distance;

3. A method for inserting a specific position of e.g. a signal in the parameterized representation of the model railroad layout according to claim 1 further comprising:
a) having the user to drive and stop the front of the locomotive in the specific position;
b) having the user to enter address of the locomotive and address of the signal;
c) having the user to confirm to insert the specific position;
d) calculate the specific position of the front of the locomotive related to the parameterized representation;
e) modify the parameterized representation to include new elements;

4. A decoder device for installation in a locomotive comprising:
a) circuit (300) for measuring an electromotive force from a motor propelling the locomotive;
b) a magnetic field sensor (302) selected from the group consisting of Hall effect sensors, MEMS sensors, digital compasses, and inertial measurement units;
wherein the improvement comprises,
c) means (304) for transmitting a data packet to a processing device;
d) means (301) for carrying out:
i) an integration of the measured electromotive force to yield an estimate of a change in position of the locomotive;
ii) an analyzation of the measured magnetic field to determine that one of the permanent magnets has been passed;

5. A decoder device of claim 4 further comprises:
a) means (301) for carrying out an analyzation of the measured magnetic field to determine between a plurality of distinguishable classes of the permanent magnets;

6. A decoder device of claim 4 where the means (304) for transmitting a data packet is a circuitry which is signaling by current pulses;

7. A computer program comprising instructions to cause the device of claim 4, 5 or 6 to execute the mentioned steps.

8. A processing device comprising:
a) a memory which is able to store a predetermined listing of maximum allowed speed for a locomotive as function of remaining distance;
wherein the improvement comprises,
b) means (403) for receiving a data packet from a decoder device;
c) a memory which is able to store a parameterized representation of a model railroad layout including known positions of a plurality of permanent magnets and one or more desirable positions;
d) means (402 or 411) for carrying out:
i) a determination of a first distance between a first passed magnet and a second passed magnet;
ii) a determination of a second distance between the second passed magnet and a third passed magnet;
iii) a search in the parameterized representation to determine an element with a best matching of the first distance and the second distance;

9. A processing device according to claim 8 further comprising:
a) means (406, 407) for disconnecting electrical connection between command station and track;
b) means (400, 408) for establishing a low impedance current loop between the connections to the track;

10. A device according to claim 8 further comprising:
a) means (402 or 411) for carrying out:
i) a calculation which determines a specific position of the front of the locomotive related to the parameterized representation;
ii) a data modification in the parameterized representation to include the specific position;

11. A computer program comprising instructions to cause the device of claim 8, 9 or 10 to execute the mentioned steps.
